(19) United States
(12) Patent Application Publication
(10) Pub. No.: US 2022/0055922 A1
(43) Pub. Date: Feb. 24, 2022

(54) SYSTEM AND METHOD FOR POOL SANITATION

(71) Applicants: Norman Mendez, Floresville, TX (US); Diego Vincenzo Mendez, Floresville, TX (US)

(72) Inventors: Norman Mendez, Floresville, TX (US); Diego Vincenzo Mendez, Floresville, TX (US)

(21) Appl. No.: 17/406,042

(22) Filed: Aug. 18, 2021

Related U.S. Application Data
(60) Provisional application No. 63/067,173, filed on Aug. 18, 2020.

(51) Int. Cl. C02F 1/28; C02F 1/00

(52) U.S. Cl. CPC C02F 1/281; C02F 2103/42; C02F 1/283; C02F 1/001

(57) ABSTRACT

An apparatus, system, and method for sanitizing water contained in a pool or a tank, includes a container to hold zeolite crystals that provide a benefit, in a first mode of operation, of removing urea and ammonia from the water as the water passes through the container and the held zeolite crystals, the held zeolite crystals removing the urea and ammonia from the water by retaining the urea and ammonia as the water passes through the container and held zeolite crystals. A switching mechanism permits the held zeolite crystals to undergo a switch into a second mode of operation during which the held zeolite crystals are exposed to a brine solution that reconditions the held zeolite crystals by desorbing from the held zeolite crystals the urea and ammonia that had been adsorbed by the held zeolite crystals during the first mode of operation.

### CROSS-REFERENCE TO RELATED APPLICATIONS

This application claims priority to U.S. Provisional Patent Application Ser. No. 63/067,173, filed Aug. 18, 2020, entitled “SYSTEMS AND METHODS FOR POOL SANITATION,” the entire contents of which are incorporated herein by reference.

### BACKGROUND

### Field of the Art

Swimming pool water or hot tub water contaminated with disinfectant by-products (DBPs) is sanitized using zeolite and/or activated black carbon in a mode 1 operation of pool water filtration, including embodiments in which the cleansing agent zeolite can itself then be reconditioned in a mode 2 reconditioning operation using a brine solution to remove filtered DBP compounds. The invention also applies to fresh water fish ponds and tanks that do not use disinfectants because such disinfectants are toxic to fish.

### Discussion of the State of the Art

Private swimming pools and hot tubs are very popular in many neighborhoods in spite of the relatively high cost of maintaining such swimming pools and hot tubs. Additionally, many communities, hotels and motels, resorts, and health clubs maintain swimming pools and/or hot tubs that are available to the public or to its members, typically contingent upon payment of a user fee.

Pool maintenance includes sanitation costs, with many pool owners typically using disinfectant agents such as chlorine in the pool water. Although pool owners may insist that visitors not urinate in their pool, water in swimming pools and hot tubs invariably is contaminated with byproducts resulting from users' urine, sweat, and other organic matter introduced by bathers, and there is currently no mechanism that precludes such contamination.

A common myth, believed by nearly half of Americans surveyed, is that a urine indicator dye exists that can be added to the water and that forms a colored cloud in an area when a user urinates in the pool, thereby supposedly discouraging users from urinating in the water because the dye would publicly embarrass the offending user. This myth remains widely circulated on signs in public pools and hot tubs in an effort to keep users from relieving themselves in the pool water rather than leaving the water to return to the changing room for such purpose. However, no such dye currently exists, and urine is difficult to detect in pool water since many compounds in urine such as uric acid, ammonia, and creatinine are unstable and react freely with pool disinfectants such as chlorine, to form disinfection by product (DBP) compounds from the original organic chemicals in urine, including, for example, combined chlorine, trihalomethanes (THMs), haloacetic acids (HAAs), haloacetonitriles (HANs), chloropicrin, and chloral hydrate.

Such DBPs can lead to eye and respiratory irritation, and long-term exposure to these compounds has been linked to asthma in professional swimmers and pool workers. Even occasional pool users often get red, bloodshot eyes after being in a swimming pool contaminated with these byproducts, including trichloramine, the volatile, irritant compound of penetrating odor commonly associated with pools treated with chlorine. Such byproducts can even build up in the air of indoor pools in sufficient amounts to induce asthma attacks. Moreover, the chemical reactions that create these disinfectant by-products also mean that there is less chlorine remaining in the water to kill the bacteria, such as E. coli, thereby requiring that more chlorine be periodically added to the pool.

A test developed by the University of Alberta, Edmonton, to estimate urine contamination in pools and hot tubs is based on measuring the concentration in pool water of an artificial sweetener, acesulfame potassium (ACE), that is commonly used in processed foods and often marketed under trade names Sunett and Sweet One, and that passes through the body unaltered. By tracking levels of this sweetener in two public pools in Canada over a three-week period, the researchers estimated that swimmers had released 75 liters of urine into one pool that was one-third the size of an Olympic pool and 30 liters of urine into a second pool about half the size of the first pool.

A conventional method to deal with DBP compounds in contaminated pool and hot tub water is to simply drain the water and refill the pool or tub with fresh water, but this water replacement process is quite costly. Although swimming pools use filtration systems incorporating sand filters, such sand filters are not effective in eliminating DBP compounds. A more recent solution uses zeolite sand in the sand filter of a pool, since zeolite sand provides a smaller filter that filters up to 90% more particles than using sand alone, and less volume of zeolite sand is used than when using sand alone. Zeolite has been used in fresh water fish tanks to filter out urea and ammonia, byproducts of fish urine, so the use of zeolite sand in a pool sand filter would also filter urea and ammonia and DBP compounds in swimming pool water. A problem in using zeolite sand in a pool sand filter is that the zeolite will eventually become saturated with the DBP compounds or urea/ammonia being filtered, requiring that the zeolite sand be periodically replaced.

### SUMMARY

The present invention provides an apparatus, system, and method to sanitize water in a swimming pool or hot tub to remove or at least reduce DBP contamination and/or urea/ammonia contamination, as demonstrated based on using zeolite to remove ammonia from freshwater aquariums, in combination with a method using brine solutions for reconditioning the zeolite, as analogously demonstrated in water softener systems that utilize brine to recondition the water softening reaction agent in such water softener systems.

The present invention relates to an apparatus for sanitizing water contained in a pool or a tank. The apparatus includes a container to hold zeolite crystals. The container is configured so that unsanitized water enters the container and passes through the held zeolite crystals in a first mode of operation in order to remove contaminants from the unsanitized water. The held zeolite crystals remove the contaminants from the unsanitized water by adsorbing the contaminants so that a fluid that exits the container is sanitized water. The apparatus further includes a switching mechanism configured for switching the apparatus between the first mode of operation and a second mode of operation. During the second mode, the held zeolite crystals are exposed to a brine solution that reconditions the held zeolite crystals by desorbing from the held zeolite crystals the contaminants that had been retained by the held zeolite crystals during the first mode of operation.

The pool or tank may include a swimming pool, and the water in the swimming pool may have added thereto a disinfection agent. The held zeolite crystals may remove the contaminants as disinfection by-product (DBP) compounds from the water as the water passes through the container and the held zeolite crystals. The brine solution in the second mode of operation may desorb the DBP compounds from the zeolite crystals. In this example, the container that holds the zeolite crystals may include a sand filter that filters the water of the swimming pool and/or a black activated carbon filter canister. The switching mechanism may include a control valve for selectively switching into the second mode of operation and for selectively switching back into the first mode of operation. The apparatus may further include a brine tank connected to the control valve, and the brine tank may be configured for holding the brine solution used in the second mode of operation. During the second mode of operation, the control valve may be configured to iteratively circulate the brine solution from the brine tank through the zeolite crystals a predetermined number of cycles and to then pass the brine solution out as waste water.

The present invention is further directed to a method of sanitizing a pool of water to remove contaminants. The method includes passing pool water from the pool through zeolite crystals. Contaminants in the pool water are adsorbed by the zeolite crystals as the pool water flows through the zeolite crystals to create filtered water. The method further includes returning the filtered water to the pool. After a predetermined amount of time, the flow of the pool water through the zeolite crystals is stopped. After stopping the flow of the pool water through the zeolite crystals, the method further includes reconditioning the zeolite crystals by exposing the zeolite crystals to a brine solution to desorb the contaminants from the zeolite crystals, thereby creating a contaminated brine solution. The contaminated brine solution is discarded as waste water. After reconditioning the zeolite crystals, the flow of water from the pool through the zeolite crystals is restarted and the filtered water is returned to the pool.

In one example, the method may further include activating a valve in a first direction to stop the flow of pool water through the zeolite crystals and start a flow of the brine solution through the zeolite crystals; and activating the valve in a second direction to stop the flow of the brine solution through the zeolite crystals and restart the flow of the pool water through the zeolite crystals. Reconditioning the zeolite crystals may include iteratively passing the brine solution through the zeolite crystals for a predetermined number of cycles before discarding the contaminated brine solution. In another example, the zeolite crystals are held in a removable container in a component of a plumbing architecture of the pool to be sanitized, and the method may further include removing the container holding the zeolite crystals and placing the removed container with the zeolite crystals into a brine tank storing the brine solution used in reconditioning the zeolite crystals.

The present invention is further directed to a method for removing contaminants from water in a pool. The method includes passing contaminated water from the pool through zeolite crystals held in a container to create filtered water, wherein the container is positioned in a flow path of a filter system of the pool; returning the filtered water to the pool; after a predetermined amount of time, stopping the flow of contaminated water from the pool through the zeolite crystals; removing the container from the flow path of the filter system; exposing the zeolite crystals to a brine solution to recondition the zeolite crystals; repositioning the container in the flow path of the filter system; and restarting the flow of contaminated water from the pool through the zeolite crystals to create filtered water. The method may further include opening a cover of a canister holding the container before removing the container from the flow path.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates the mode 1 pool water sanitation mode of the present invention, in which pool water is filtered.

FIG. 1B illustrates the mode 2 reconditioning mode of the present invention, in which saturated zeolite is reconditioned.

FIG. 2 illustrates skimmer baskets from various manufacturers, as commonly used in pool filtration systems.

FIG. 3 illustrates exemplarily how a conventional skimmer basket can be modified to hold zeolite crystals while continuing to serve their intended purpose of collecting debris skimmed off the pool water surface, as used in an exemplary embodiment of the present invention.

FIG. 4 illustrates a system for filtering pool water and reconditioning zeolite crystals, in accordance with the present invention.

FIG. 5 illustrates an exemplary embodiment of the present invention demonstrating the use of one or more containers holding zeolite and one or more brine tanks for reconditioning the zeolite.

FIG. 6 illustrates an exemplary embodiment of the present invention demonstrating the use of modified skimmer baskets to hold zeolite.

FIG. 7 illustrates an exemplary embodiment of the present invention demonstrating the use of baskets to hold zeolite, as added to the sand filter.

FIG. 8 illustrates an exemplary embodiment of the present invention demonstrating the use of control valves to control the brine solution for reconditioning the zeolite as held in the sand filter.

FIG. 9 illustrates an exemplary embodiment of the present invention demonstrating the use of control valves to control the brine solution for reconditioning the zeolite as held in modified skimmer baskets.

FIG. 10 is a flow chart of a method for sanitizing water in accordance with one embodiment of the present invention.

### DETAILED DESCRIPTION

The methods and systems disclosed herein are for sanitizing water, such as pool water, fish tank water, water in a man-made pond, or the like. The method includes passing the water through a filter that includes zeolite crystals. The DBP compounds are filtered out of the water by the zeolite crystals. When the zeolite crystals become saturated with DBP compounds, the zeolite crystals can be replaced or regenerated. As such, the method may further include a step of periodically regenerating the zeolite crystals by passing a brine solution through the zeolite crystals. The brine solution effectively removes the DBP compounds from the zeolite crystals so that the zeolite crystals can be re-used in the filtering process. In one embodiment, the zeolite crystals are added to a skimmer basket in a swimming pool. In another embodiment, a filter including the zeolite crystals is incorporated into the water filtration system. This embodiment may further include a brine tank and a switch for switching between the filtration process and the zeolite crystal regenerating process.

The invention is described by reference to various elements herein. It should be noted, however, that although the various elements of the inventive apparatus are described separately below, the elements need not necessarily be separate.The various embodiment may be interconnected and may be cut out of a singular block or mold.The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The following description is of exemplary embodiments of the invention only and is not intended to limit the scope, applicability, or configuration of the invention in any way. Rather, the following description is intended to provide a convenient illustration for implementing various embodiments of the invention. As will become apparent, various changes may be made in the function and arrangement of the elements described in these embodiments without departing from the scope of the invention as outlined in the appended claims.

### Overview

The method and system of the present invention is based on using zeolite crystals and, in some exemplary embodiments, activated black carbon, to remove disinfection by-products (DBPs) from swimming pool and hot tub water, analogous to the method of using zeolite to remove urea and ammonia from freshwater fish tanks and aquariums. Additionally and analogous to the function of a brine tank in a water softener system, a brine tank permits the zeolite crystals to be reconditioned to remove ammonia/urea and/or DBP contaminants that have collected in and on the zeolite crystals. The activated black carbon is used in some exemplary embodiments to additionally assist in removing odors as a one off application, since activated black carbon would not be reconditioned if subjected to the brine solution used in reconditioning the zeolite crystals.

In explaining the present invention, it is noted that zeolite is a collective name for minerals and chemical compounds in the group of silicates. Zeolites are microporous, hydrated aluminosilicate minerals commonly used in industry as commercial adsorbents and catalysts. Zeolites occur naturally as crystalline compounds of volcanic origin and have microporous structures of Si- and Al-tetrahedrons (SiO4, AlO4) linked through the common oxygen atoms to form an open crystal structure. Zeolites are also readily available as a synthetic material.

Zeolites are widely used as ion-exchange beds in domestic and commercial water purification, softening, and other applications and are used in chemistry to separate molecules for analysis, since only molecules of certain sizes and shapes can pass through, and as traps for molecules too large to pass through the microporous structures.

Although exemplary embodiments are described as sanitizing water having DBP contaminants, such as swimming pool water, it should be clear to one having ordinary skill in the art that the technique of using zeolite crystals for water sanitization is also applicable in situations in which there is no disinfectant such as chlorine added to the water. More specifically, since chlorine is toxic to fish, it is vital that no chlorine be in the water used in fish ponds and tanks. Thus, the waste products from fish in such ponds or pools or tanks do not form DBP contaminants such as described above for swimming pools having chlorinated water. However, zeolite will also filter out ammonia and urea as fish waste products, so the techniques described herein apply equally to sanitizing water in fish ponds, pools, or tanks having no disinfectants added to the water. In general, zeolite adsorbs contaminants from water. The contaminants may be DBPs, ammonia, urea, or the like.

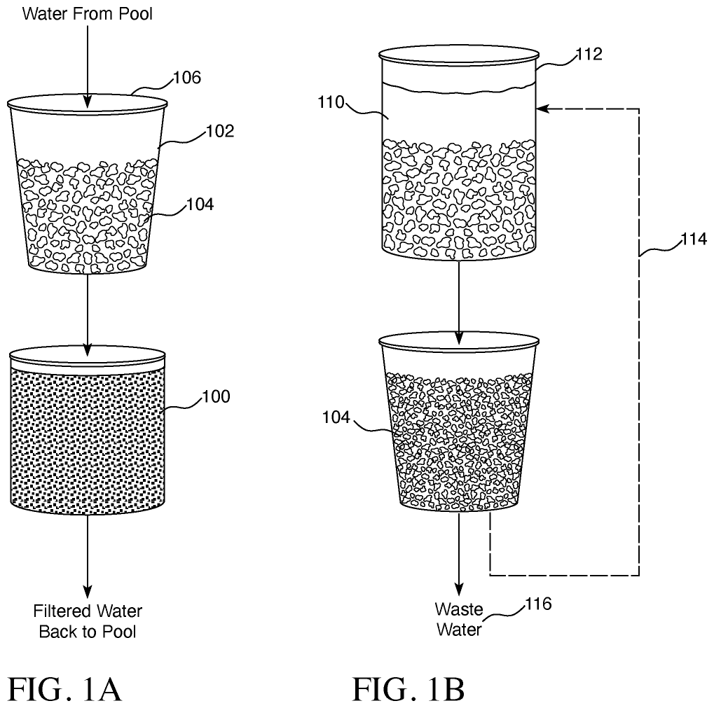

The present invention is based on using two modes for conditioning pool water. In the first mode, shown exemplarily in FIG. 1A, pool water is filtered by circulating the pool water in the conventional manner through a sand filter 100. However, the present invention should be viewed as introducing zeolite crystals 104 into the conventional filter method, the zeolite crystals 104 having the purpose of attracting contaminants to extract urine products during this conventional water filtering mode. Thus, as will be further explained, the zeolite 104 can be physically located in various places in the conventional filtering path, as an alternative to placing the crystals in the skimmer basket 102, as exemplarily demonstrated in FIG. 1A.

In the first mode shown in FIG. 1A in which pool water is filtered, the zeolite crystals 104 will eventually become saturated with DBP contaminants. Therefore, the present invention introduces into the conventional pool filtration method the second mode shown exemplarily in FIG. 1B, in which the saturated zeolite crystals 104 are then exposed to a brine solution 110, for the purpose of reconditioning the zeolite crystals104 by removing the DBP contaminants that have accumulated on the crystals 104. In particular, the DBP compounds that are adsorbed by the zeolite crystals 104 are subsequently desorbed from the zeolite crystals 104 by exposing the zeolite crystals 104 to the brine solution 110. At the end of the second mode, the zeolite crystals 104 will have been reconditioned, so that the first mode shown in FIG. 1A can then be reinstated to again permit filtration through the sand filter 100 and continuing removal of DBP contaminants using the reconditioned zeolite crystals 104. The reconditioning of zeolite can be achieved either by using a brine solution source that is built into the pool filtration plumbing architecture in some exemplary embodiments or, in alternative exemplary embodiments, by lifting the skimmer basket 102 from the pool skimmer and exposing the zeolite 104 to a brine solution 110 in a container that is distinct from the normal pool filtration plumbing architecture.

In explaining an exemplary embodiment of the invention involving skimmer baskets, it is noted that in typical swimming pool plumbing architectures, water from the pool enters into a conventional pool sand filter 100 via one or more pool skimmers. Thus, FIG. 1A illustrates an exemplary embodiment of the invention in which the zeolite crystals 104 have been located in the pool skimmer basket 102, which would be one method to conveniently and simply introduce benefits of the present invention into conventional pool systems without extensive modification of the pool plumbing architecture. In this exemplary embodiment, the conventional skimmer basket 102 has been modified to form a small lip 106 at the top surface of the skimmer basket 102, so that the basket 102 is able to continue to perform its conventional intended function of collecting debris floating on the water surface while additionally holding zeolite crystals 104 at the bottom of the basket 102. Placing the zeolite crystals 104 in the modified skimmer baskets 102 permits at least part of the pool water flowing to the pool sand filter 100 to pass through the zeolite crystals 104 enroute to the sand filter 100 during the mode 1 filtering of the pool water using the sand filter 100. In one embodiment, the skimmer basket 102 includes a lower compartment for holding the zeolite crystals 104 and an upper compartment for holding any debris that is collected from the water surface. There may be a partition between the lower compartment and the upper compartment in order to hold the zeolite crystals in place in the lower compartment.

FIG. 1B exemplarily illustrates the second mode in which the zeolite is reconditioned, using a brine solution 110 stored in brine tank 112. In exemplary embodiments in which the brine tank 112 is incorporated into the pool filtration plumbing architecture, the brine solution 110 is pumped from the brine tank 112, using, for example, the pump used during mode 1 operation for pumping pool water through the sand filter 100. In other exemplary embodiments, a separate pump could be incorporated for the mode 2 reconditioning processing, and in other exemplary embodiments, the brine tank 112 is separate from the pool filtration plumbing. Mode 2 is used to “back flush” the zeolite crystals 104 located, for example, in the skimmer baskets 102, to recondition the zeolite crystals 104 by removing contaminants accumulated during mode 1 filtering.

As exemplarily shown by the dotted line 114 in FIG. 1B, mode 2 would typically circulate the brine solution 110 several times through the zeolite crystals 104, before being discarded as waste water 116.

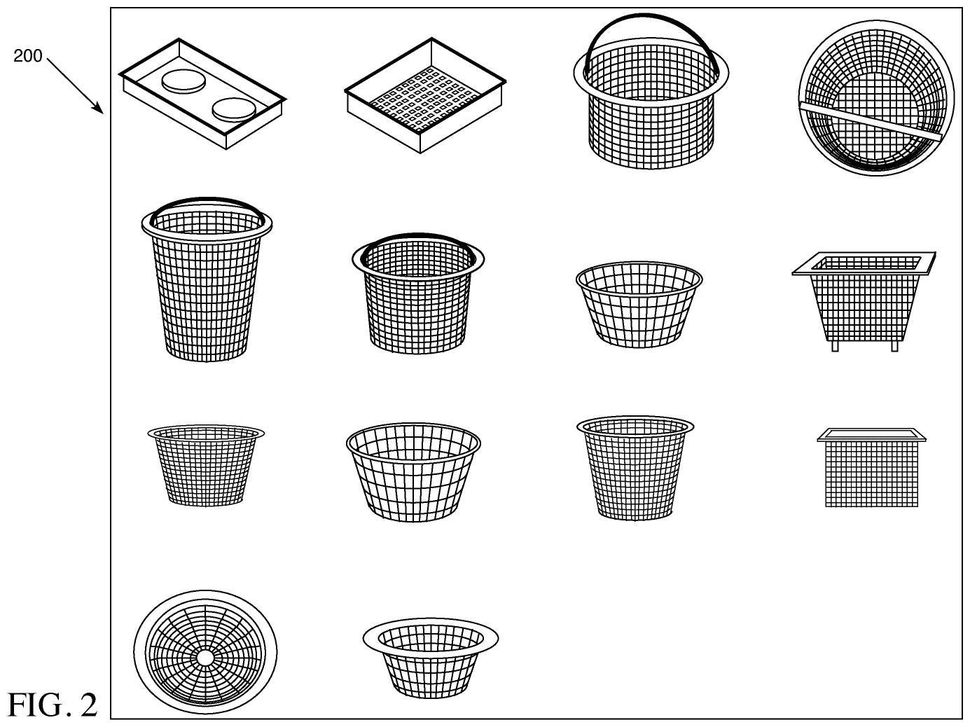

In an exemplary embodiment, the zeolite crystals 104 are located in the pool skimmer baskets 102. As well known in the art, a pool skimmer is a component of a conventional pool system that allows an overflow of surface water into a suction pipe that provides pool water to the sand filter 100 for water filtration. The purpose of the pool skimmer is to catch large debris floating on the surface of the pool water prior to the water entering into the filter 100, with the floating debris being captured in the skimmer basket 102, which can be lifted out of the skimmer compartment so that the debris can be discarded. There may be one to five or even more skimmers, depending upon the pool size. The skimmers are typically located around the periphery of a pool as a canister covered by, for example, a 10-inch disk, and a pool skimmer basket 102 is fitted inside the skimmer and is removable after unfastening the cover disk, so that the skimmer basket 102 is accessible for emptying out any large floating debris such as leaves and sticks that have been collected in the skimmer basket 102. FIG. 2 exemplarily shows various conventional skimmer baskets 200 provided by different pool equipment suppliers.

The exemplary embodiment described in FIG. 1A and FIG. 1B places the zeolite crystals 104 in the skimmer baskets 102. However, this location is chosen primarily as a convenient location for conventional pool configurations, since the zeolite 104 could be located elsewhere and still achieve the benefit of removing contaminants during mode 1 filtering of the pool water. For example, the zeolite 104 could be located in the sand filter 100 or in its own separate canister inserted in series or in parallel with the sand filter 100 during the mode 1 filtering, so that at least a portion of the pool water passes through the zeolite 104 during normal mode 1 pool water filtering. If located in the sand filter 100, the zeolite 104 could be stored in its own container placed, for example, at the top of the sand filter 100, so that the zeolite 104 could be easily lifted out from the sand filter 100 for purpose of mode 2 reconditioning of the zeolite.

This alternative exemplary embodiment in which the zeolite 104 is added to the sand filter 100 in its own removable container could also be desirable for conventional pool configurations in which the benefits of zeolite of the present invention can be easily added to the conventional sand filter 100, while additionally permitting the mode 2 reconditioning of the zeolite 104 to be implemented without having to modify the conventional pool configuration to incorporate a brine tank in an existing pool plumbing architecture. Thus, in this exemplary alternative embodiment, the brine tank 112 could be separate from the pool filtration configuration using the sand filter 100, and could even be ancillary equipment specifically provided to perform reconditioning of the zeolite 104, as one step in periodic pool maintenance procedures by the pool owner. Alternatively, the brine tank 112 could be a special tool available, for example, as provided by a pool maintenance provider who provides maintenance services to pool owners, including the service of implementing the mode 2 reconditioning of zeolite 104 as part of periodic pool maintenance.

If, on the other hand, the zeolite 104 is incorporated in the sand filter 100, either as a substitute for the sand or as a substitute for a portion of the sand, then the mode 2 reconditioning of the zeolite 104 shown in FIG. 1B would involve flushing the sand filter 100 with brine for several iterations, followed by discarding the brine solution 110 as waste water, before returning the sand filter 100 back into mode 1 operation for normal pool water filtration.

### Apparatus

In the exemplary embodiment shown in FIG. 1A and FIG. 1B, the present invention modifies the conventional skimmer basket 200 (illustrated in FIG. 2) to permit the basket to hold zeolite crystals 104 at the bottom of the skimmer basket 102 while still serving its conventional function of capturing large objects skimmed off the surface of pool water.

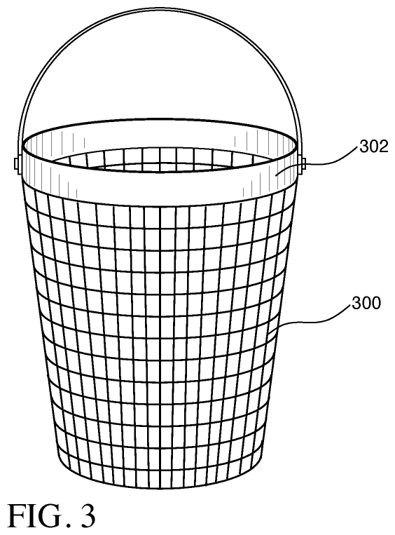

FIG. 3 exemplarily illustrates how any of the various conventional skimmer baskets 200 shown in FIG. 2 could easily be modified by adding a lip 302 at the top edge of the basket 300 of, for example, 1 inch in height, to permit the zeolite 104 to be held at the bottom of the skimmer basket 300 while the added lip 302 at the top provides an adequate edge that would capture debris that enters through the skimmer port. It is noted that, depending on the specific dimensions of specific conventional baskets, some of the various conventional skimmer baskets 200 shown in FIG. 2 may require no modification to be able to hold zeolite crystals 104 at the bottom of the basket while maintaining sufficient space at the top to still perform the function of capturing debris, as dependent upon how much zeolite 104 is placed in the bottom of the basket. In one example, the skimmer basket 300 includes an upper compartment and a lower compartment. The zeolite crystals are held in the lower compartment. In this example, there may be a partition between the upper compartment and the lower compartment in order to hold the zeolite crystals in place and prevent them from being carried away by the water flowing through the basket 300.

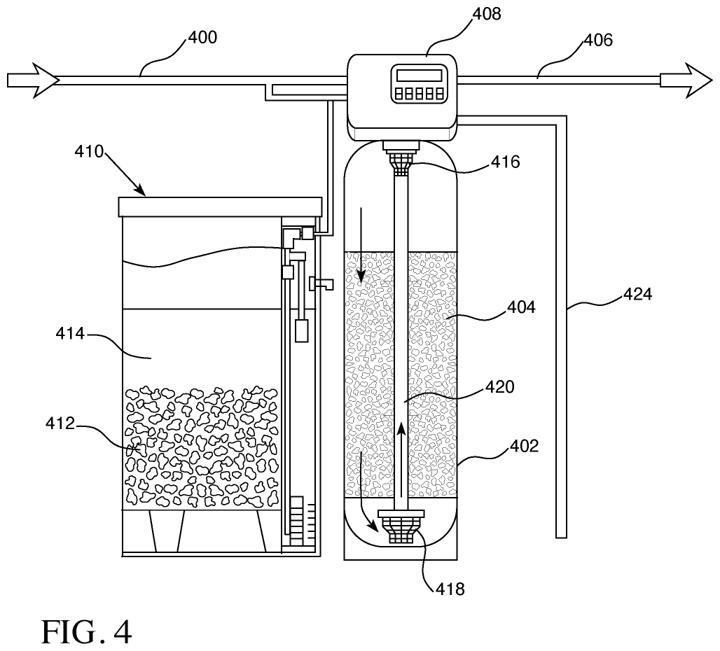

To assist in understanding the reconditioning mode of the present invention shown in FIG. 1B, an exemplary configuration of components is shown in FIG. 4, in which zeolite 404 used for filtering pool water 400 is shown as contained in one canister 402 and a second canister, the brine tank 410, holds salt 412 which forms a brine solution 414 when water is added to the brine tank 410.

When unfiltered pool water 400 enters into the zeolite filter tank 402, the unfiltered pool water 400 flows through the zeolite crystals 404, which act as a medium for filtering out DBP contaminants from the pool water 400. However, in accordance with concepts of the present invention, as the zeolite crystals 404 filter out the DBP contaminant, the zeolite crystals 404 get saturated so that over time, the zeolite crystals 404 would no longer be able to continue filtration of the DBP contaminants.

To address this loss of filtration capability, a control valve 408 includes, for example, a meter that tracks the amount of unfiltered pool water 400 that enters into the zeolite filter tank 402. Before the zeolite crystals 404 become too saturated, the control valve 408 will automatically initiate a regeneration cycle involving the associated brine tank 410 storing a brine solution 414 resulting from salt 412 stored at the bottom of the brine tank 410. During mode 1 filtering of pool water, control valves in the control head 408 cause input pool water 400 to enter the zeolite filter tank 402 via top diffuser 416 to pass through the zeolite crystals 404 and then pass through the bottom diffuser 418 and output manifold 420, to then exit as filtered pool water 406.

In the mode 2 regeneration cycle, control valves in the control head 408 allow the brine solution 414 to be forced into the zeolite filter tank 402, which causes the captured DBP contaminants to be back flushed out of the zeolite crystals 404, ultimately being discharged as waste water through drain line 424. Upon completion of the regeneration cycle, the zeolite crystals 404 are again in condition to continue removing DBP contaminants from the input unfiltered pool water 400. During the regeneration cycle, the flow of unfiltered pool water 400 into the zeolite filter tank 402 is turned off.

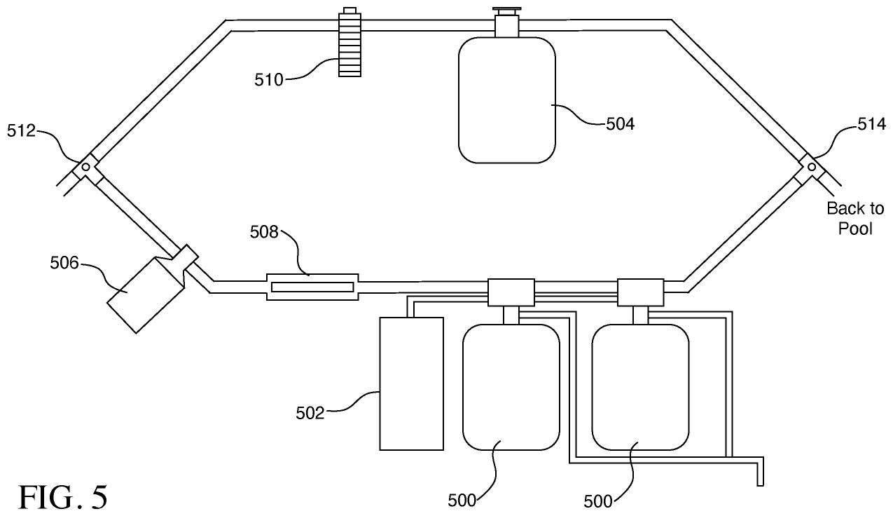

FIG. 5 illustrates an exemplary embodiment of the invention in which the zeolite filter(s) 500 and brine tank 502 are configured in parallel with the sand filter 504, so that one part of the pool water goes through the sand filter 504 and part goes through the zeolite filters 500 during the mode 1 filtering process. The zeolite path in this exemplary embodiment also includes a one-time use black activated carbon filter 506 and UV sterilizer 508, and the sand filter path includes an in-line chlorinator 510. In mode 1 filtering, valves 512, 514 cause pool water to divide into two flows, one water flow going into the sand filter 504 path and the second water flow going into the zeolite 500 path. During mode 2 reconditioning, valves 512, 514 prevent pool water from entering, and the brine solution in brine tank 502 is circulated through the zeolite filters 500, typically using an iterative recycling process that passes the brine solution through the zeolite filters 500 multiple times, and then discharging the brine solution as waste water. Upon discharge as waste water, a new brine solution is created as fresh water enters into the brine tank 502 as the former brine solution is discharged as waste water, and the newly entered fresh water interacts with rock salt stored in the brine tank 502.

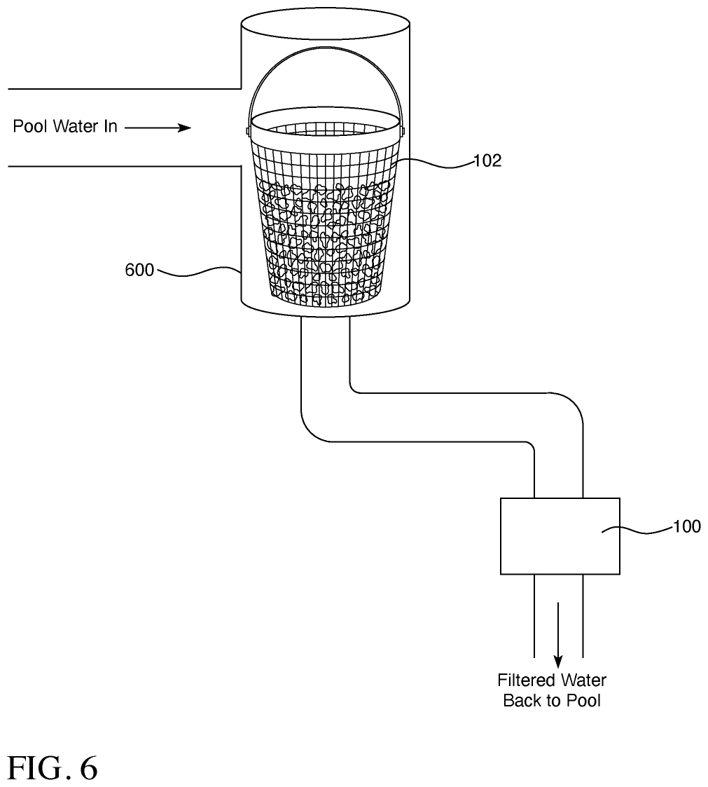

FIG. 6 illustrates an exemplary simple embodiment in which the zeolite is held in modified skimmer baskets 102 so that mode 1 filtering occurs whenever pool water is pumped through the sand filter 100. Mode 2 reconditioning occurs by lifting the modified skimmer baskets 102 out of the skimmer compartments 600 and subjecting the skimmer baskets 102 with their zeolite crystals to a brine solution, which is external to the pool filtering path and components. The brine solution used for the mode 2 reconditioning could be held in a container (not shown in FIG. 6) onsite to the pool, or could be provided as a facility by a pool maintenance service provider.

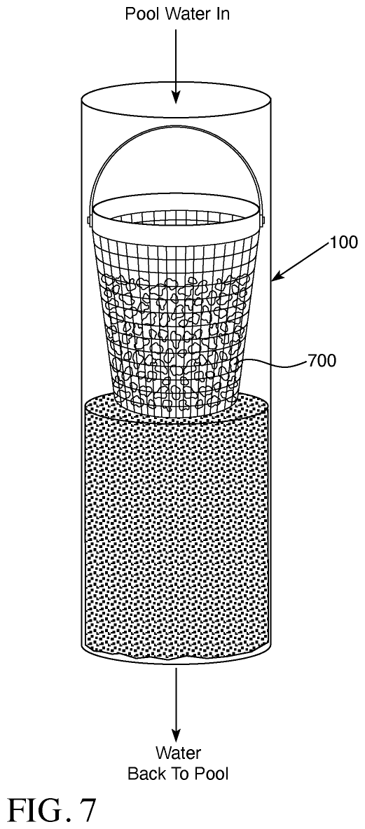

FIG. 7 illustrates another exemplary simple embodiment to incorporate zeolite into conventional pool architectures without extensive modifications. In this embodiment, the zeolite is loaded into a removable basket 700 at the top of the sand filter 100 such that mode 1 filtering occurs using zeolite and sand filter 100. Mode 2 reconditioning of the zeolite occurs by lifting the zeolite basket 700 out of the top of the sand filter 100 and subjecting it to a brine solution, as described above for FIG. 6.

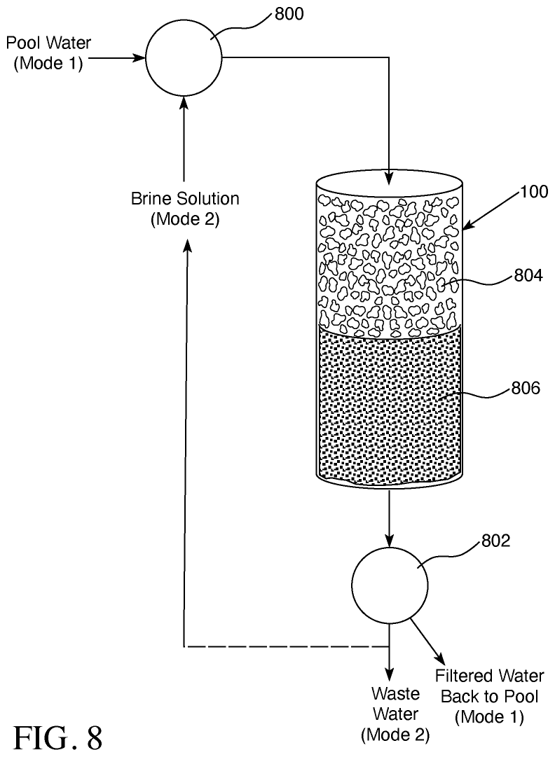

FIG. 8 illustrates an exemplary embodiment in which zeolite 804 is added to the conventional sand filter 100, either as a partial or complete substitute for sand 806 originally used in the sand filter 100. Mode 1 filtering occurs by pumping pool water through the sand filter 100 containing zeolite 804 and sand 806, and mode 2 reconditioning occurs by using the pump to circulate the brine solution through the sand filter 100 a predetermined number of cycles and then overboard as waste water, as controlled by mode control valves 800, 802.

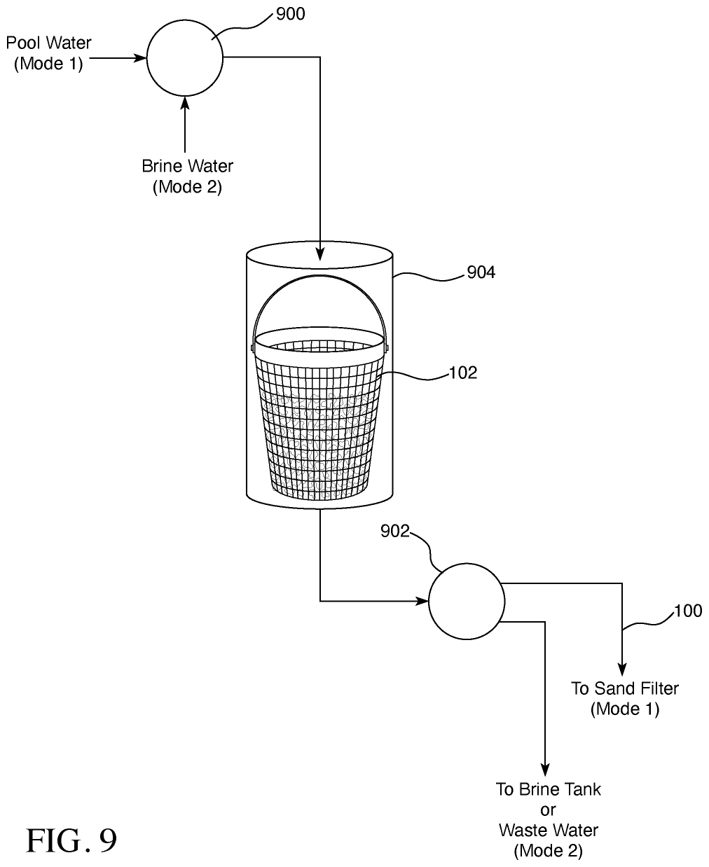

FIG. 9 illustrates an exemplary embodiment in which again the zeolite is held in modified skimmer baskets 102, so that mode 1 filtering occurs by pumping pool water from the pool through the skimmers 904 and into the sand filter 100. Mode 2 reconditioning occurs by iteratively circulating the brine solution through the zeolite and then overboard as waste water. Mode control valve 900 controls whether pool water (mode 1) or brine solution (mode 2) flows into the skimmer 904 (and the zeolite), and mode control valve 902 controls whether output flow of the skimmer 904 goes to the sand filter 100 (mode 1) or is recirculated and ultimately output as wastewater (mode 2).

Although schematics of FIG. 5 through FIG. 9 describe various specific exemplary embodiments of the invention, one of ordinary skill in the art would readily recognize that there are numerous possible variations. For example, an important element in an exemplary embodiment is the use of a brine tank to recondition zeolite used for filtering and sanitizing pool and hot tub water. Accordingly, it should be clear that even though an exemplary embodiment of the invention describes placing the zeolite in a skimmer basket, the zeolite could alternately be physically located in the pool sand filter or even in a separate canister rather than in skimmer basket(s). For example, in yet another exemplary embodiment, zeolite crystals could be placed in the one-time use black activated carbon filter 506 shown in FIG. 5 rather than adding zeolite filter(s) 500 and brine tank 502. In this exemplary embodiment, the zeolite could be placed in the activated carbon filter canister 506 as a replacement of the black activated carbon or could be added to the canister 506 as a replacement for a portion of the black activated carbon. Additionally, rather than adding the brine tank 502 for rejuvenating the zeolite in the activated carbon filter canister 506, the zeolite could be incorporated in the canister 506 using a removable basket, thereby permitting the zeolite to be lifted out of the canister 506 for reconditioning of the zeolite using a brine solution that is not incorporated in the pool plumbing.

Additionally, although various figures describe pool configurations in which all components are interconnected as shown with fixed plumbing, it should be clear that such fixed connection is not required and that there are alternative embodiments. For example, the present invention discloses using zeolite as a sanitizing agent for pool and tub water, including exemplary embodiments in which the zeolite is provided in skimmer baskets. Therefore, as a possible variation of the invention, the pool/tub owner or a company providing pool/tub servicing could achieve the benefit of sanitizing water by temporarily replacing the conventional skimmer baskets with modified skimmer baskets which temporarily include zeolite crystals, as part of a periodic temporary sanitizing service for the pool/tub. Such modification would be attractive for pool/tub owners who do not wish to modify their existing pool/tub architecture while still taking advantage of the benefits of the present invention. As part of this variation, the zeolite used in the temporary sanitizing procedure could then be subsequently treated with brine solution to recondition the zeolite for another sanitizing procedure.

Other variations from that suggested in the various exemplary configurations include the control of the valves used to direct the different water flows. That is, these water paths could be controlled using manual switching by the pool/tub owner or a company providing periodic servicing, or the paths could be controlled using an automatic switching analogous to that described in the water softening system described relative to FIG. 4. Path control could also be achieved by having attachment fixtures incorporated into pool/tub plumbing such that the owner or service provider would be able to temporarily attach to the plumbing for the purpose of providing temporary servicing such as a periodic water sanitizing procedure.

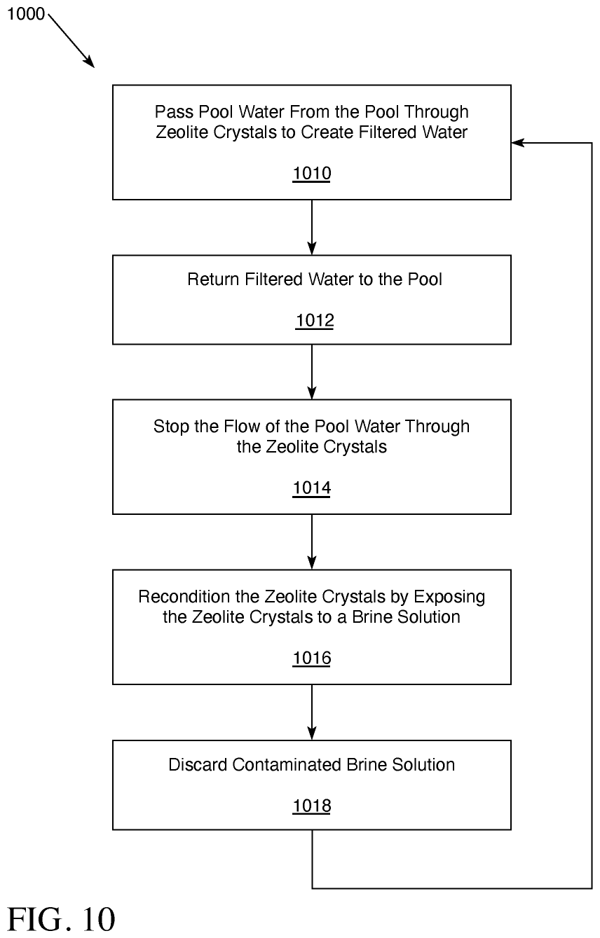

With reference to FIG. 10, a method 1000 for sanitizing a pool of water to remove contaminants will be described. In step 1010, pool water from the pool is passed through zeolite crystals. Contaminants in the pool water are adsorbed by the zeolite crystals as the pool water flows through the zeolite crystals to create filtered water. Next, in step 1012, the filtered water is returned to the pool.

During the filtering process of steps 1010 and 1012, the zeolite crystals will eventually become saturated with the contaminants. As such, after a predetermined amount of time, the flow of the pool water through the zeolite crystals is stopped in step 1014. Next, in step 1016, the zeolite crystals are reconditioned by exposing the zeolite crystals to a brine solution to desorb the contaminants from the zeolite crystals, thereby creating a contaminated brine solution. In one example, steps 1014 and 1016 may include activating a valve in a first direction to stop the flow of pool water through the zeolite crystals and start a flow of the brine solution through the zeolite crystals. In another example, the zeolite crystals are held in a removable container (such as a skimmer basket) in a component of a plumbing architecture of the pool and the method 1000 further includes a step (not shown) of removing the container holding the zeolite crystals and placing the removed container with the zeolite crystals into a brine tank storing the brine solution used in reconditioning the zeolite crystals. Before removing the container, a cover of a canister holding the container may need to be opened. Step 1016 may further include iteratively passing the brine solution through the zeolite crystals for a predetermined number of cycles before discarding the contaminated brine solution in step 1018.

After the zeolite crystals are reconditioned and the contaminated brine solution is discarded in step 1018, the flow of water from the pool through the zeolite crystals is restarted by returning to step 1010. In one example, stopping the flow of the brine solution and restarting the flow of the pool water may include activating the valve in a second direction. In another example, the removable container may be repositioned in the flow path of the pool's filter system before restarting the flow of the pool water in step 1010.

Although the present invention is directed toward pools of water treated with a disinfectant such as chlorine, so that urea and ammonia removal includes removal of chloramines and other disinfectant by-products (DBPs), as previously mentioned, one of ordinary skill in the art would readily recognize that the invention is also applicable to pools of water without disinfectants added. For example, fish tanks and fish ponds use water that must be dechlorinated, since chlorine is toxic to fish. A recent popular trend is to provide a fish pond stocked with expensive fish such as koi. The present invention therefore provides a sanitation system and method by which urea and ammonia from fish urine can be removed from water in a fresh-water fish tank or pond in a manner by which the sanitizing agent can be periodically reconditioned.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for cleaning fabric through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An apparatus for sanitizing water contained in a pool or a tank, the apparatus comprising:
a container to hold zeolite crystals, wherein the container is configured so that unsanitized water enters the container and passes through the held zeolite crystals in a first mode of operation in order to remove contaminants from the unsanitized water, the held zeolite crystals removing the contaminants from the unsanitized water by adsorbing the contaminants so that a fluid that exits the container is sanitized water; and
a switching mechanism configured for switching the apparatus between the first mode of operation and a second mode of operation during which second mode the held zeolite crystals are exposed to a brine solution that reconditions the held zeolite crystals by desorbing from the held zeolite crystals the contaminants that had been retained by the held zeolite crystals during the first mode of operation.

2. The apparatus of claim 1, wherein the pool or tank comprises a swimming pool, wherein the water in the swimming pool has added thereto a disinfection agent, and wherein the held zeolite crystals remove the contaminants as disinfection by-product (DBP) compounds from the water as the water passes through the container and the held zeolite crystals, and wherein the brine solution in the second mode of operation desorbs the DBP compounds from the zeolite crystals.

3. The apparatus of claim 2, wherein the container that holds the zeolite crystals comprises at least one of a sand filter that filters water of the swimming pool and a black activated carbon filter canister.

4. The apparatus of claim 2, wherein the switching mechanism comprises a control valve for selectively switching into the second mode of operation and for selectively switching back into the first mode of operation, wherein apparatus further comprises a brine tank connected to the control valve, and wherein brine tank is configured for holding the brine solution used in the second mode of operation.

5. The apparatus of claim 4, wherein, during the second mode of operation, the control valve is configured to iteratively circulate the brine solution from the brine tank through the zeolite crystals a predetermined number of cycles and configured to then pass the brine solution out as waste water.

6. A method of sanitizing a pool of water to remove contaminants, the method comprising:
passing pool water from the pool through zeolite crystals, wherein contaminants in the pool water are adsorbed by the zeolite crystals as the pool water flows through the zeolite crystals to create filtered water;
returning the filtered water to the pool;
after a predetermined amount of time, stopping the flow of the pool water through the zeolite crystals;
after stopping the flow of the pool water through the zeolite crystals, reconditioning the zeolite crystals by exposing the zeolite crystals to a brine solution to desorb the contaminants from the zeolite crystals, thereby creating a contaminated brine solution;
discarding the contaminated brine solution as waste water; and
after reconditioning the zeolite crystals, restarting the flow of water from the pool through the zeolite crystals and the returning of the filtered water to the pool.

7. The method of claim 6, further comprising:
activating a valve in a first direction to stop the flow of pool water through the zeolite crystals and start a flow of the brine solution through the zeolite crystals; and
activating the valve in a second direction to stop the flow of the brine solution through the zeolite crystals and restart the flow of the pool water through the zeolite crystals.

8. The method of claim 6, wherein reconditioning the zeolite crystals comprises iteratively passing the brine solution through the zeolite crystals for a predetermined number of cycles before discarding the contaminated brine solution.

9. The method of claim 6, wherein the zeolite crystals are held in a removable container in a component of a plumbing architecture of the pool to be sanitized and wherein the method further comprises removing the container holding the zeolite crystals and placing the removed container with the zeolite crystals into a brine tank storing the brine solution used in reconditioning the zeolite crystals.

10. A method for removing contaminants from water in a pool, wherein the method comprises:
passing contaminated water from the pool through zeolite crystals held in a container to create filtered water, wherein the container is positioned in a flow path of a filter system of the pool;
returning the filtered water to the pool;
after a predetermined amount of time, stopping the flow of contaminated water from the pool through the zeolite crystals;
removing the container from the flow path of the filter system;
exposing the zeolite crystals to a brine solution to recondition the zeolite crystals;
repositioning the container in the flow path of the filter system; and
restarting the flow of contaminated water from the pool through the zeolite crystals to create filtered water.

11. The method of claim 10, wherein the method further comprises opening a cover of a canister holding the container before removing the container from the flow path.
